(19) United States
(12) Patent Application Publication
(10) Pub. No.: US 2007/0221795 A1
(43) Pub. Date: Sep. 27, 2007

(54) Structure and system for creating shelving and storage units

(76) Inventor: Gerald Cutty, Franklin, WI (US)

Correspondence Address: Absolute Technology Law Group, LLC, Fourth Floor, 207 East Michigan Avenue, Milwaukee, WI, 53202, US

(21) Appl. No.: 11/711,536

(22) Filed: Feb. 27, 2007

Related U.S. Application Data
(60) Provisional application No. 60/786,175, filed on Mar. 27, 2006.

(51) Int. Cl. F16M 13/00

(52) U.S. Cl. 248/158; 248/235

(57) ABSTRACT

An apparatus for supporting shelves or other furniture comprised of: a top horizontal support member; a horizontal immobilizing base member; and a center member connected on one end to the top horizontal support member and on a second end to the immobilizing base member in which the apparatus can be positioned on a first furniture-type object or floor and on which a second furniture-type object can be placed and supported. The apparatus can be Z-shaped, H-shaped, Y-shaped, T-shaped, or I-shaped, can include apertures for securing it to the furniture-type objects, one or more non-skid layers, and ornamentation. The apparatus can also be used as book ends.

### CROSS-REFERENCE TO RELATED APPLICATIONS

This application claims priority to and the benefit of U.S. provisional patent application Ser. No. 60/786,175, filed on Mar. 27, 2006 and incorporated herein in its entirety.

### FIELD OF INVENTION

This invention relates generally to the field of furniture and specifically to an apparatus for modifying the configuration of furniture to include or create shelves or storage structures.

### BRIEF DESCRIPTION OF THE DRAWINGS

FIG. 1 is a top perspective view of one embodiment of two (2) support structures on a desk and supporting a shelving unit.

FIG. 2a is a side view of the embodiment of the support structure shown in FIG. 1 taken along line 2-2.

FIG. 2b is a side view of an alternate embodiment of the support structure.

FIG. 2c is a side view of an alternate embodiment of the support structure in which the support structure is I-shaped.

FIG. 3 is a side view of a Z-shaped embodiment of the support structure in which the immobilizing base member has a plurality of apertures to permit affixation of the support structure to an underlying horizontal surface.

FIG. 4 is a side view of a Z-shaped support structure in which the immobilizing base member has an adhesive to permit the structure to be affixed to an underlying horizontal surface.

FIG. 5 is a side view of a Z-shaped embodiment of the support structure in which an ornamentation is affixed.

FIG. 6 is a side view of an I-shaped embodiment of the support structure further including a non-skid layer affixed to the immobilizing base member to prevent sliding or skidding.

FIG. 7 shows an Z-shaped embodiment of the support structure further including an additional support member to further support the top horizontal support member.

### BACKGROUND OF THE INVENTION

In certain instances it is desirable to create one or more shelves or storage structures on an underlying horizontal surface capable of securely bearing the weight of books, supplies, stereo equipment, tools or other objects and to have convenient structures or components available for doing so which may give the appearance of continuity or architectural symmetry with the underlying structure of which the horizontal surface is a part. It may also be desirable to modify the function of previously constructed furnishings by adding structures which function as shelving units and to have convenient structures which may be adapted to the dimension of a previously constructed furniture unit, or to the accommodate the dimension of specific shelving.

The term “horizontal surface” generally refers any surface on which an object is capable of resting.

The term “Z-shaped” generally refers a shape for a structure or apparatus which contains a member or feature placed at angle between to parallel members or features.

The term “I-shaped” generally refers a shape for a structure or apparatus which contains a member or feature placed perpendicularly between to parallel members or features.

The term “clamp” generally refers to a device which secures an object secure to another object or a tool for holding objects securely in place.

The term “immobilizing base member” generally refers to a base component of a device which is adapted to securely bear the weight of structural components of the device, as well as the weight of objects placed upon or supported by the device without sliding, skidding, or shifting position. The immobilizing base member may include non-skid material on its lower surface which comes in contact with furniture or flooring, but may also be constructed of material that prevents skidding or sliding.

The term “securing component” generally refers to a screw, nail, bolt, clamp, or other securing mechanism or component used to secure an object in place, and when necessary, the device may further include an aperture for the placement of a screw, nail, bolt, clamp, or other securing mechanism.

### DETAILED DESCRIPTION OF EMBODIMENT OF THE INVENTION

The drawings include exemplary embodiments to the invention, which may be embodied in various forms. It is to be understood that in some instances various aspects of the invention may be shown exaggerated or enlarged to facilitate an understanding of the invention. Furthermore, with reference to the drawings, the reader should understand that like reference numerals in different drawings refer to the like elements and components of the invention. Moreover, it should be noted that each embodiment of the invention is not depicted by the figures.

Detailed descriptions of the embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

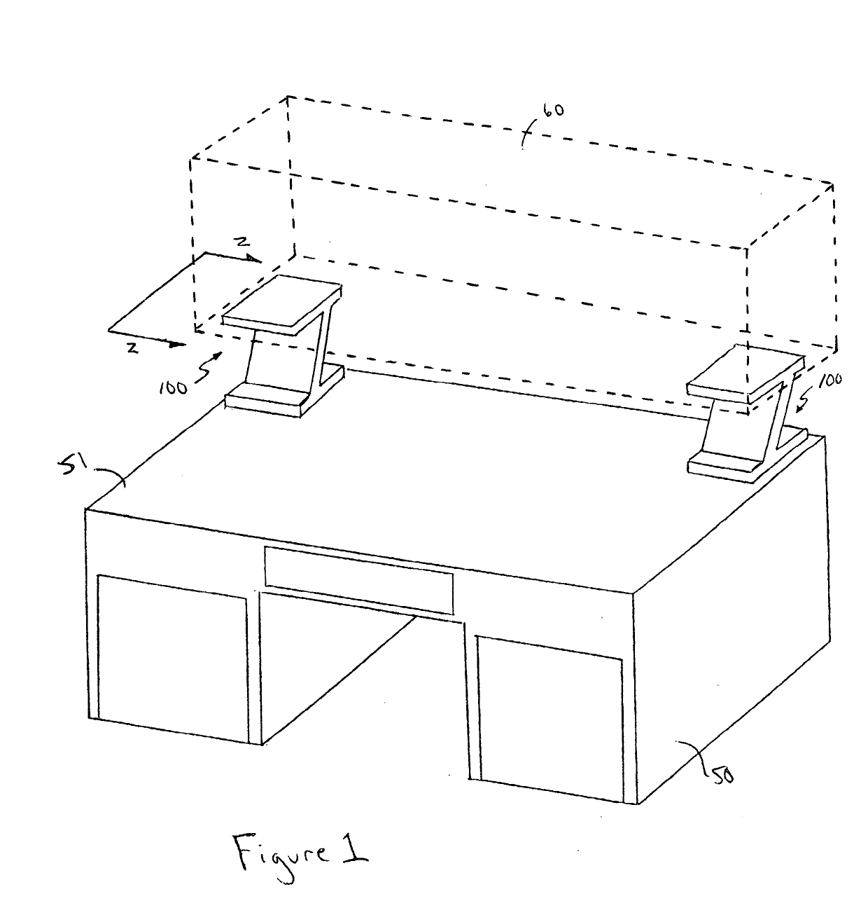

FIG. 1 is a top perspective view of two (2) support structures 100 on desk 50 and supporting shelving unit 60. Shelving unit is shown in broken lines to allow full view of support structures 100. As can be appreciated, support structures 100 are positioned on top surface 51 of desk 50, and shelving unit 60 is supported by support structures 100. It should be understood, however, that support structures 100 can be used with any type of furniture, including but not limited to desk 50, shelving unit, 60, computer desks, tables, workbenches, credenzas, cabinets, filing cabinets, and other related furniture. It should also be understood that the number and position of support structures can also be modified. That is, other numbers of support structures 100 can be used, including three (3) or more, or a single support structure 100, though use of a single support structure will require that it be substantially wider than the embodiment shown in FIG. 1. In the embodiment shown, support structures 100 are capable of bearing weight ranging from zero (0) to two hundred fifty (250) pounds. Other embodiments may be capable of bearing additional weight.

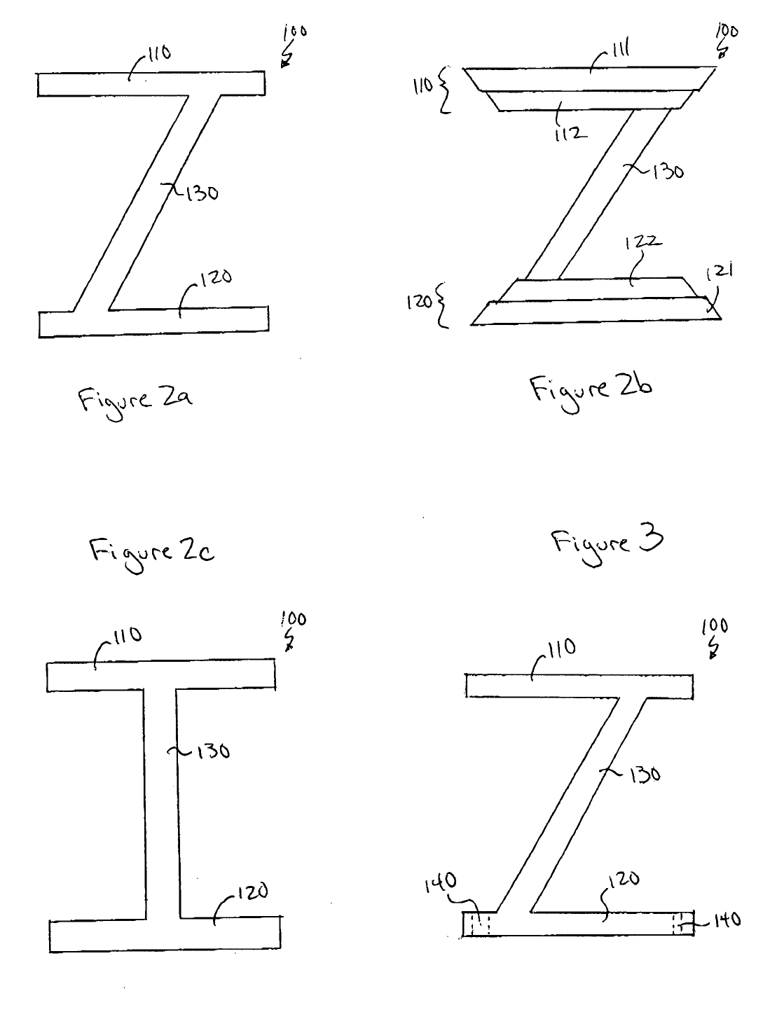

FIG. 2a is a side view of the embodiment of support structure 100 shown in FIG. 1 taken along line 2-2. As can be seen, support structure 100 is constructed of a single piece to form: top horizontal support member 110, on which an object (e.g., a shelving unit, not shown), can be placed and supported; bottom horizontal immobilizing base member 120, which is adapted to allow support structure 100 to rest on a second object (e.g., a desk, not shown); and center member 130, which maintains top horizontal support member 110 and immobilizing base member 120 positioned apart and parallel to one another. The one-piece construction of support structure 100 can be made of plastic or metal that can be manufactured by injection molding, heat bending, an extrusion process, or by other means commonly known and used in the art.

Although the embodiment of support structure 100 is shown in a substantially Z-shape, it should be understood that support structure 100 can be constructed in alternate configurations. For example, support structure 100 can alternately be in an I-shape (as shown in FIGS. 2c and 6), as well as in a Y-shape, H-shape, or a T-shape. Regardless of the shape, the bottommost portion of support structure 100 functions as immobilizing base member 120.

FIG. 2b is a side view of an alternate embodiment of support structure 100 in which support structure 100 is constructed of multiple pieces. As can be seen, top horizontal support member 110 has two (2) pieces, upper portion 111 and lower portion 112. Upper portion 111 of top horizontal support member 110 is eleven and three-quarters inches (11¾″), with the ends mitered at forty-five degrees (45°). Lower portion 112 is slightly shorter in length and also mitered at forty-five degrees (45°). Upper portion 111 and lower portion 112 of top horizontal support member 110 are secured to one another by screws, but can alternately be secured to one another by any means known in the art. Similarly, immobilizing base member 120 is constructed of upper portion 122 and lower portion 121, which are secured to one another by screws, but can alternately be secured to one another by any means commonly known in the art. Center member 130 is ten and one-half inches (10½″) long and angled at thirty degrees (30°) with its ends mitered to thirty degrees (30°) such that the distance between upper portion 122 of immobilizing base member 120 and lower portion 112 of top horizontal support member 110 is approximately five and one-half inches (5½″). Center member 130 is secured to top horizontal support member 110 and immobilizing base member 120 by two (2) screws (not shown). In the embodiment shown, support structure 100 is made of pine wood, but may alternately be made of any man-made or natural substance such as other woods, any metal or alloy, plastic, glass, stone, or of any other material of sufficient strength and durability to support shelving or storage units, including combinations thereof. In an alternate embodiment, support structure 100 is of sufficient weight to function as one (1) or more bookends and has a material, pads, or sheeting applied to immobilizing base member 120 to prevent sliding (as described in detail infra).

FIG. 2c is a side view of an alternate embodiment of support structure 100 in which support structure 100 is I-shaped. As with the Z-shaped embodiments shown in FIGS. 2a and 2b, support structure 100 is comprised of top horizontal support member 110, immobilizing base member 120, and center member 130. Although the embodiment is shown as being constructed of a single piece, it should be understood that a multi-piece construction can also be used, and that top horizontal support member 110, immobilizing base member 120, and center member 130 can be secured to one another by any means provided supra or other.

FIG. 3 is a side view of a Z-shaped embodiment of support structure 100 in which immobilizing base member 120 has a two (2) apertures 140 to permit affixation of support structure 100 to an underlying horizontal surface, e.g., the desk shown in FIG. 1. Screws, nails, bolts, or another element commonly used in the art can be used to penetrate apertures 140 and secure support structure 100 to the underlying surface. Although not shown, top horizontal support member 110 can also have one (1) or more apertures within it to allow support structure to be secured to the object being supported by support structure 100, e.g., the shelving unit 60 shown in FIG. 1. In addition, it should be understood that any number of apertures 140 can be employed, and that apertures can be on only top horizontal support member 110, on only immobilizing base member 120, or both, and that the same number of apertures 140 need not be on top horizontal support member 110 as on immobilizing base member 120. One of ordinary skill in the art will appreciate that support structure 100 can also be temporarily secured to the underlying surface and/or that the object supported by support structure 100 to support structure 100 by a clamp (not shown).

FIG. 4 is a side view of a Z-shaped embodiment of support structure 100 in which immobilizing base member 120 further includes adhesive 150. Adhesive 150 is positioned between immobilizing base member 120 and the underlying surface (e.g., the top surface of desk 50) to permit support structure 100 to be affixed to the underlying horizontal surface. It should be understood that adhesive 150 can instead be positioned above top horizontal support member 110 to secure the object on support structure 100 to be secured thereto, and that adhesive 150 can be at both positions. In alternate embodiments of support structure 100, support structure 100 can be secured to the underlying surface and/or the object being supported by support structure 100, the underlying surface and/or the object being supported can be secured to support structure 100 by suction cups, double-sided tape, a hook and latch mechanism, sticky tabs, glue, and combinations thereof.

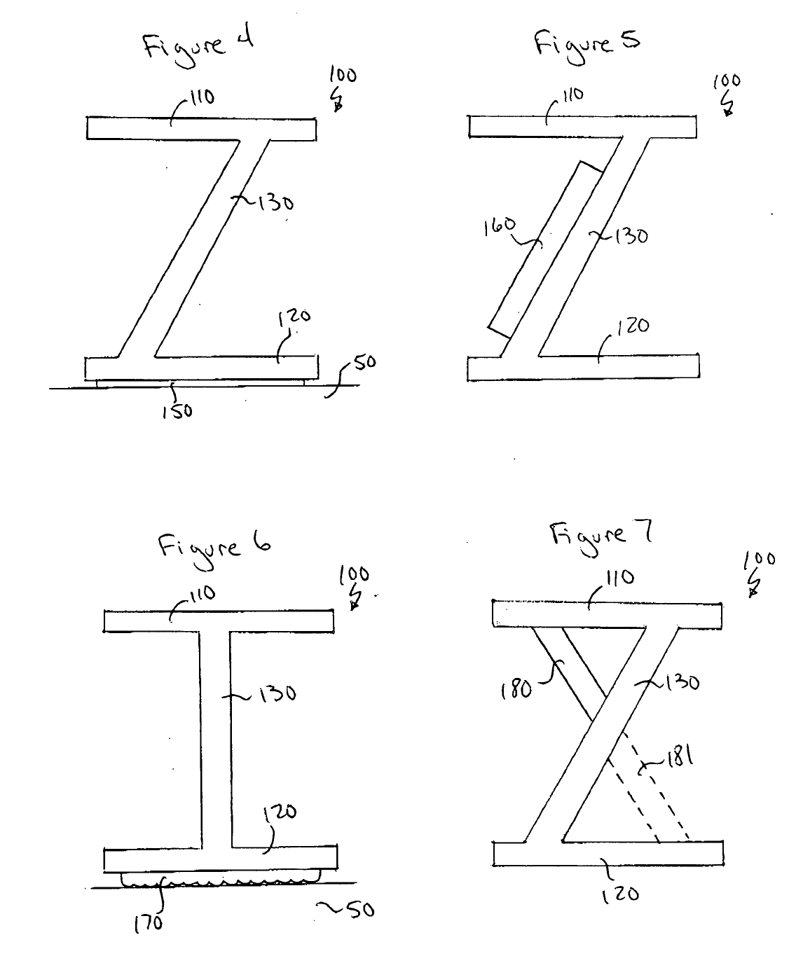

FIG. 5 is a side view of a Z-shaped embodiment of support structure 100 in which ornamentation 160 is affixed to center member 130. In the embodiment shown, ornamentation 160 is a corkboard within a wooded frame. However, it should be understood that any ornamentation 160 can be secured to support structure 100. Ornamentation may be functional, such as corkboard or molding, and is intended to alter the aesthetic appearance of support structure 100 without affecting its support function. Although not show here, the ornamentation may also or instead be affixed to top horizontal support member 110 and/or immobilizing base member 120.

FIG. 6 is a side view of an I-shaped embodiment of support structure 100 further including non-skid layer 170 affixed to immobilizing base member 120. Non-skid layer 170 prevents sliding or skidding of support structure 100, but without permanently or temporarily securing support structure 100 to underlying surface 50. It should be understood, too, that non-skid layer can also be positioned on top of top horizontal support member 110 to prevent sliding or skidding of the object supported by support structure 100. In the embodiment shown, non-skid layer 170 is a rubber gripper pad, but can be any other means for preventing support structure 100 from slipping or sliding relative to the underlying object or the object supported by support structure 100 without securing support structure 100 to the underlying object and/or the object supported by support structure 100.

FIG. 7 shows an Z-shaped embodiment of support structure 100 further including additional support member 180 to further support top horizontal support member 110. Additional support member 180 provides extra support for top horizontal support member 110. In addition, additional support member 181 can be used to provide additional support to immobilizing base member 120 (shown in broken lines). In still another embodiment of support structure 100, support structure 100 can include two (2) additional support members 180, 181. In other embodiments additional support member 181 may be placed in any vertical, horizontal, or angular configuration (such as a Y-shape) capable of additional support.

While support structure 100 has been shown and described with respect to several embodiments and uses in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

1. An apparatus comprised of:
a top substantially horizontal support member;
a bottom substantially horizontal immobilizing base member; and
a center member having a first end and a second end, said first end connected to said top horizontal support member and said second end connected to said bottom immobilizing base member said center member capable of securely bearing weight;
wherein said apparatus is adapted to be positioned on a first object and on which a second object can be placed and supported.

2. The apparatus of claim 1, wherein said first object and said second object are selected from a group comprised of a shelf, a desk, a shelving unit, a table, a credenza, a floor surface, a work bench, a shelving unit, a cabinet, a filing cabinet, and combinations thereof.

3. The apparatus of claim 1, wherein said apparatus is constructed as a multi-piece construction or a single-piece construction, said single-piece construction formed from a method selected from a group comprised of injection molding, heat bending, and an extrusion process.

4. The apparatus of claim 1, wherein said top horizontal support member, said immobilizing base member, and said center member are made of a material selected from a group comprised of wood, a metal, an alloy, a plastic, glass, stone, and combinations thereof.

5. The apparatus of claim, wherein said apparatus is further comprised of at least one securing component, said at least one securing component selected from a group comprised of at least one screw, at least one nail, at least one bolt, at least one suction cup, a double-sided tape, a hook and latch mechanism, at least one sticky tab, glue, and combinations thereof

6. The apparatus of claim 1, wherein said apparatus is further comprised of at least one ornamentation positioned thereon.

7. The apparatus of claim 1, wherein said apparatus is further comprised of a non-skid layer positioned on a lower surface of said immobilizing base member, said non-skid layer selected from a group comprised of a rubber gripper pad.

8. The apparatus of claim 1, wherein said apparatus is further comprised of an additional support member.

9. An apparatus for supporting a first object comprised of:
a top horizontal support member;
a bottom horizontal immobilizing base member;
a center member having a first end and a second end, said first end connected to said top horizontal support member and said second end connected to said immobilizing base member; and
a securing component selected from a group comprised of at least one screw, at least one nail, at least one bolt, at least one suction cup, a double-sided tape, a hook and latch mechanism, at least one sticky tab, glue, and combinations thereof;
wherein said apparatus is adapted to be positioned on a second object, said first object and said second object being a furniture-type object selected from a group comprised of a desk, a shelving unit, a table, a credenza, floor surface, a work bench, a shelving unit, a cabinet, a filing cabinet a floor surface, and combinations thereof.

10. The apparatus of claim 9, wherein said apparatus is constructed as a multi-piece construction or a single-piece construction, said single-piece construction formed from a method selected from a group comprised of injection molding, heat bending, and an extrusion process.

11. The apparatus of claim 9, wherein said top horizontal support member, said immobilizing base member, and said center member are made of a material selected from a group comprised of wood, a metal, an alloy, a plastic, glass, stone, and combinations thereof.

12. The apparatus of claim 9, wherein said apparatus is further comprised of at least one ornamentation positioned thereon.

13. The apparatus of claim 9, wherein said apparatus is further comprised of a non-skid layer positioned on at least one of said immobilizing base member, and said top horizontal support member, said non-skid layer selected from a group comprised of a rubber gripper pad.

14. The apparatus of claim 9, wherein said apparatus is further comprised of an additional support member.

15. A removable shelving system for supporting a shelf comprised of:
a plurality of apparatuses, each of said plurality of apparatuses comprised of:
a top horizontal support member;
an immobilizing base member;
a center member having a first end and a second end, said first end connected to said top horizontal support member and said second end connected to said immobilizing base member; and
a securing component, said securing component selected from a group comprised of at least one screw, at least one nail, at least one bolt, at least one suction cup, a double-sided tape, a hook and latch mechanism, at least one sticky tab, glue, and combinations thereof;
wherein said system is adapted to be positioned on at least one object, said object selected from a group comprised of a desk, a shelving unit, a table, a credenza, floor surface, a work bench, a shelving unit, a cabinet, a filing cabinet, and combinations thereof.

16. The removable shelving system of claim 15, wherein said removable shelving system is further comprised of a first apparatus which may be placed at an adjustable distance from a second apparatus.

17. The removable shelving system of claim 15, wherein a first of said plurality of apparatuses may be placed at an adjustable distance from a second of said plurality of apparatuses.

18. The removable shelving system of claim 15, wherein each of said plurality of apparatuses is further comprised of at least one ornamentation positioned thereon.

19. The removable shelving system of claim 15, wherein each of said plurality of apparatuses is constructed as a multi-piece construction or a single-piece construction, said single-piece construction formed from a method selected from a group comprised of injection molding, heat bending, and an extrusion process.

20. The removable shelving system of claim 15, wherein each of said plurality of apparatuses is made of a material selected from a group comprised of wood, a metal, an alloy, a plastic, glass, stone, and combinations thereof.
